(19) United States
(12) Patent Application Publication
(10) Pub. No.: US 2007/0135174 A1
(43) Pub. Date: Jun. 14, 2007

(54) Mobile telephone and an accessory

(76) Inventors: William Henry Howe Musk, Pretoria (ZA); Ronald Joseph Sarkin, Johannesburg (ZA); Gerhardus Stephanus De Beer, Johannesburg (ZA)

Correspondence Address: LADAS & PARRY, 26 WEST 61ST STREET, NEW YORK, NY, 10023, US

(21) Appl. No.: 10/569,258

(22) PCT Filed: Aug. 17, 2004
(86) PCT No.: PCT/IB04/02676

§ 371 Date: Feb. 20, 2007

(30) Foreign Application Priority Data
Aug. 20, 2003 (ZA) 2003/6498

(51) Int. Cl. H04M 1/00

(52) U.S. Cl. 455/569.1

(57) ABSTRACT

An accessory for a cellular telephone has a stand for the telephone and a microphone and speaker, with the speaker and microphone of the accessory being connected to circuitry of the telephone when the telephone is on the stand, with a speaker and microphone of the telephone being disabled. The accessory may also have a lamp, a radio, a clock and a screen. The accessory may further have a charger for charging the telephone, in a wireless manner. The telephone thus has charging circuitry for converting radiated energy into electrical energy.

This invention relates to cellular telephones and accessories therefor.

According to a first aspect of the invention there is provided an accessory for use with a cellular telephone, which includes
a stand engageable with the telephone;
a microphone;
a speaker; and
   a connecting means for connecting the microphone and speaker to circuitry of the telephone.

Further according to this aspect there is provided a cellular telephone for use with the accessory, which includes a complementary connecting means for connecting circuitry of the telephone to a microphone and speaker of the accessory.

According to a second aspect of the invention there is provided a cellular telephone, which includes
a rechargeable power supply;
a radiated energy receiving unit; and
a rectifying means for rectifying received radiated energy.

Further according to this aspect there is provided an accessory for use with a telephone in accordance with the second aspect, which includes a power radiating device for supplying the telephone with radiated power for recharging the power supply thereof.

Thus the stand may also incorporate a charging device for charging a power supply of the telephone. This may be done in a radiated manner in accordance with the second aspect of the invention, or in a mechanically connected manner. In the latter case the stand and the telephone may have complementary connectors.

The connecting means may also operate in a wireless manner, such as Bluetooth.

The telephone may be a sealed device, although it may have a replaceable cover.

The accessory may have further components such as a lamp, a radio and a clock. It may also have a screen whereby the user may access the Internet via the telephone.

In a preferred embodiment the telephone may be sufficiently small to be worn on a user's arm, and having a wrist strap. The stand may then have an arm on which the telephone may be supported.

The invention is now described by way of example with reference to the accompanying diagrammatic drawings, in which

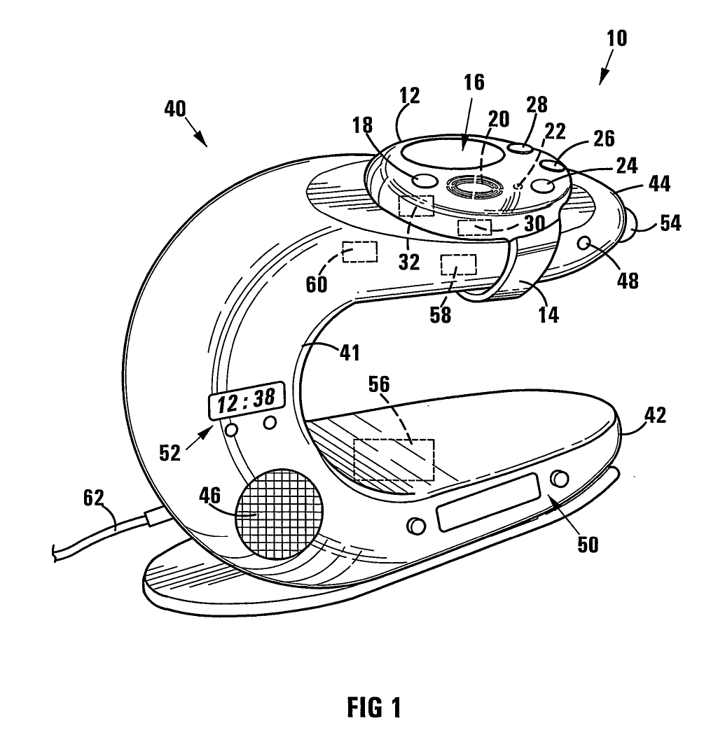

FIG. 1 shows a schematic view of a first embodiment of an accessory for a cellular telephone and a telephone therefor, in accordance with the invention;

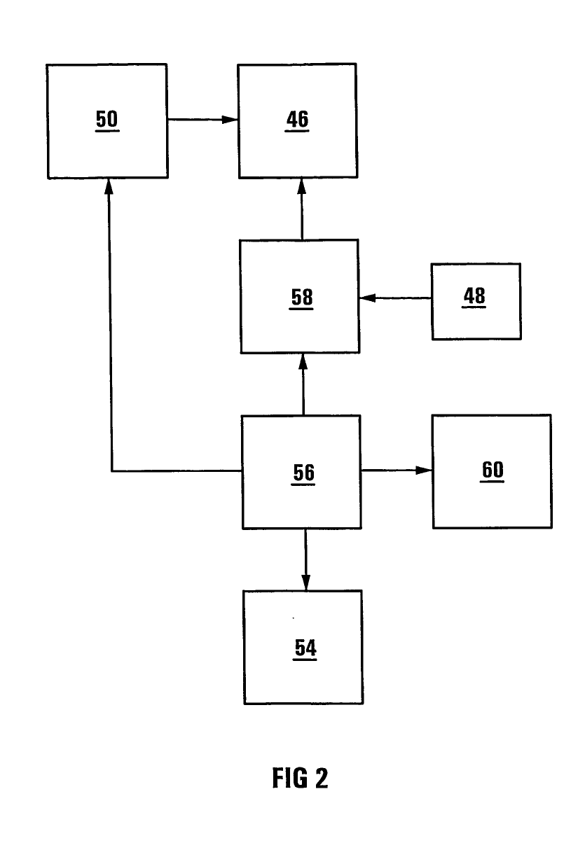

FIG. 2 shows a block diagram of components of the accessory of FIG. 1; and

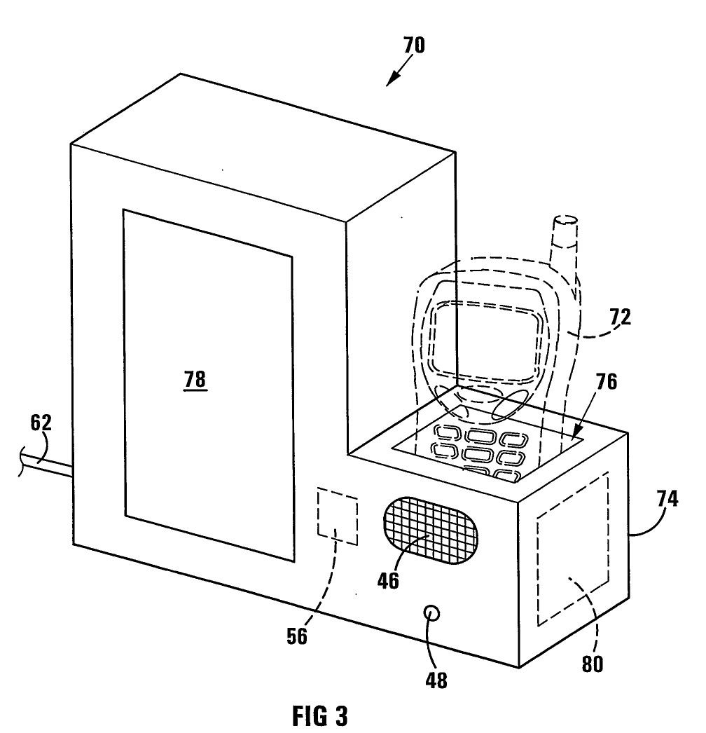

FIG. 3 shows a schematic view of a second embodiment of an accessory for a cellular telephone in accordance with the invention.

Referring now to FIG. 1 a cellular telephone in accordance with the invention is designated generally by reference numeral 10. The telephone 10 is sufficiently small to be worn on a person's wrist and has a body 12 with a strap 14. The telephone 10 is of the GSM type and, in common with other cellular telephones, it has a screen 16, an ON/OFF switch 18, a speaker 20 and a microphone 22. The telephone 10 also has other common components, such as an aerial, a SIM card holder, electronic circuitry, a battery, a GPRS module and the like, which are not shown in FIG. 1.

The telephone 10 also has buttons 24 and 26 by means of which a voice connection may be established, via the cellular network, with two particular predesignated numbers. A further button 28 is used to terminate such voice connections.

It will be appreciated that the telephone 10 also operates as a normal telephone in regard to incoming voice calls, and these may be accepted and terminated by means of the buttons 24 and 28.

More importantly, the telephone 10 has a Bluetooth module 30 by means of which it is connectable to associated circuitry in an accessory 40 as will be explained below.

In addition, the telephone 10 is a sealed unit and has a wireless charger 32 by means of which it receives radiated energy from the accessory 40 and rectifies it to recharge the battery referred to above.

Referring now to the accessory 40 (with reference also to the block diagram shown in FIG. 2), it will be seen that the accessory 40 includes a stand 41 which has a base 42 and an arm 44 on which the telephone 10 is received. Further as shown, the stand 41 incorporates a speaker 46, a microphone 48, a radio 50, a clock 52, a lamp 54, a power supply 56, a Bluetooth module 58 and a wireless charger 60 for the telephone 10. The power supply 56 is connected to an electricity supply by a cable 62.

As will be appreciated, when the telephone 10 is supported on the arm 44, the Bluetooth modules 30 and 58 connect to one another and the speaker 46 and microphone 48 of the accessory 40 are enabled and the speaker 20 and microphone 22 of the telephone are disabled. Thereby, if the telephone 10 is used for a call, aural and oral communication are effected by means of the speaker 46 and microphone 48, in a “conference” manner.

Similarly, when the telephone 10 is supported on the arm 44, the battery of the telephone 10 is automatically charged.

Referring to FIG. 3, a further embodiment 70 of an accessory for use with a cellular telephone 72 is shown. This accessory 70 is similar to the accessory 40 and is similarly referenced. However, the accessory 70 has a stand 74 with a connecting arrangement 76 having appropriate mechanical connectors engageable with standard, or special purpose complementary connectors of the telephone 72. The accessory 70 also has a screen 78, whereby the user of the telephone 72 may access the Internet via the telephone 72, using navigation buttons of the telephone 72. Further, the power supply 56 charges the telephone 72 via the connecting arrangement 76. As shown, the accessory 70 has a speaker 46 and a microphone 48 and circuitry 80 for connecting relevant circuitry of the telephone 72 to the speaker 46 and microphone 48.

1. An accessory for use with a cellular telephone, which includes a stand engageable with the telephone; a microphone; a speaker; and a connecting means for connecting the microphone and speaker to circuitry of the telephone.

2. The accessory as claimed in claim 1, in which the connecting means is operable in a wireless manner.

3. The accessory as claimed in claim 1, in which the connecting means includes a mechanical connector.

4. The accessory as claimed in claim 1, which includes a charging device for supplying power to the telephone to charge a battery thereof.

5. The accessory as claimed in claim 1, in which the charging device is operable in a wireless manner.

6. The accessory as claimed in claim 1, which includes a lamp.

7. The accessory as claimed in claim 1, which includes a radio.

8. The accessory as claimed in claim 1, which includes a clock.

9. The accessory as claimed in claim 1, which includes a screen whereby a user of the accessory may access the Internet via the telephone.

10. A cellular telephone which includes
a rechargeable power supply;
a radiated energy receiving unit; and
a rectifying means for rectifying received radiated energy.

11. A cellular telephone for use with an accessory as claimed in claim 1, which includes a complementary connecting means for connecting circuitry of the telephone to a microphone and speaker of the accessory.

12. (canceled)
